(19) United States
(12) Patent Application Publication
(10) Pub. No.: US 2021/0146649 A1
(43) Pub. Date: May 20, 2021

(54) COMPRESSIBLE SHEET

(71) Applicant: SAINT-GOBAIN PERFORMANCE PLASTICS CORPORATION, Solon, OH (US)

(72) Inventor: Jean-Yvon FAOU, Maisons-Alfort (FR)

(21) Appl. No.: 17/252,941

(22) PCT Filed: Jun. 25, 2019
(86) PCT No.: PCT/US19/38924

§ 371 Date: Dec. 16, 2020

Related U.S. Application Data
(60) Provisional application No. 62/689,934, filed on Jun. 26, 2018.

(51) Int. Cl. B32B 3/12; B32B 7/14

(52) U.S. Cl. CPC B32B 3/12; B32B 27/40; B32B 7/14

(57) ABSTRACT

A compressible sheet may include a structured core. The structured core may include an elastomer material. The compressible sheet may have an average height of not greater than about 5 mm. The structured core may further include a density of not greater than about 500 g/m². The compressible sheet may further include a densification strain of at least about 40%.

### TECHNICAL FIELD

The present disclosure relates to a compressible sheet, and more particularly to, a compressible cellular sheet for use as a battery pack spacer.

### BACKGROUND ART

Electric vehicle battery packs may include several electrolyte pouches. During charging and discharging of the vehicle battery packs, the electrolyte pouches expand and retract. In order to the electrolyte pouches in position, a resilient spacer material may be used to conform and accommodate the strain of the expanding and retracting electrolyte pouches. For example, a spacer material can be used to maintain a reactively constant stress response under strain of the expanding and retracting electrolyte pouches. Accordingly, there is a continuing need for improved spacer designs to use in electric vehicle battery packs.

### BRIEF DESCRIPTION OF THE DRAWINGS

Embodiments are illustrated by way of example and are not limited to the accompanying figures.

FIG. 1 includes a sample compression curve from a compression test;

FIG. 2 includes an illustration of a compressible sheet having a structured core with a lattice structure according to embodiments described herein;

FIG. 3 includes an illustration of a compressible sheet having a structured core with a corrugated wave structure according to embodiments described herein;

FIG. 4 includes an illustration of a compressible sheet having a structured core with a corrugated beam structure according to embodiments described herein;

FIGS. 5a-5c include illustrations of compressible sheets according to embodiments described herein;

FIGS. 6a & 6b include illustrations of compressible sheets according to embodiments described herein;

FIGS. 7a-7e include plots of the compression curves for sample compressible sheets formed according to embodiments described herein;

FIGS. 8a & 8b include plots of the compression curves for sample compressible sheets formed according to embodiments described herein;

FIGS. 9a & 9b include plots of the compression curves for sample compressible sheets formed according to embodiments described herein; and

FIGS. 10a-10f include plots of the compression curves for sample compressible sheets formed according to embodiments described herein.

Skilled artisans appreciate that elements in the figures are illustrated for simplicity and clarity and have not necessarily been drawn to scale.

### SUMMARY

According to a first aspect, a compressible sheet may include a structured core. The structured core may include an elastomer material. The compressible sheet may further have an average thickness of not greater than about 5 mm.

According to another aspect, a compressible sheet may include a structured core. The structured core may include an elastomer material. The structured core may further include a surface density of not greater than about 500 g/m².

According to yet another aspect, a compressible sheet may include a structured core. The structured core may include an elastomer material. The compressible sheet may further include a densification strain of at least about 40%.

According to yet another aspect, a battery pack spacer may include a compressible sheet. The compressible sheet may include a structured core. The structured core may include an elastomer material. The compressible sheet may further have an average height of not greater than about 5 mm.

According to still another aspect, a battery pack spacer may include a compressible sheet. The compressible sheet may include a structured core. The structured core may include an elastomer material. The compressible sheet may further include a surface density of not greater than about 500 g/m².

According to still another aspect, a battery pack spacer may include a compressible sheet. The compressible sheet may include a structured core. The structured core may include an elastomer material. The compressible sheet may include a densification strain of at least about 60%.

### DETAILED DESCRIPTION OF THE PREFERRED EMBODIMENT(S)

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

As used herein, the term “surface density” refers to the mass per unit area distributed on the in-plane surface of a sample. For purposes of embodiments described herein, surface density may be determined by measuring the mass of a sample of the compressible sheet and calculating the surface density in grams per square meter according to the following equation: Surface Density=M/(L×W)×10⁶, where M is the mass of the sample in grams, L is the length of the sample in mm, and W is the width of the sample in mm.

As used herein, the term “volume density” refers to the mass per unit volume of a sample. For purposes of embodiments described herein, volume density may be determined by 1) measuring the height (H) of a sample of the compressible sheet using a dial foot applying a force of 0.8±0.2 N, 2) determining the mass (M) of the sample in grams, and 3) calculating the volume density in grams per liter according to the following equation: Volume Density=M/(L×W×H)×10⁶, where M is the mass of the sample in grams, L is the length of the sample in mm, W is the width of the sample in mm and H is the height of the sample in mm.

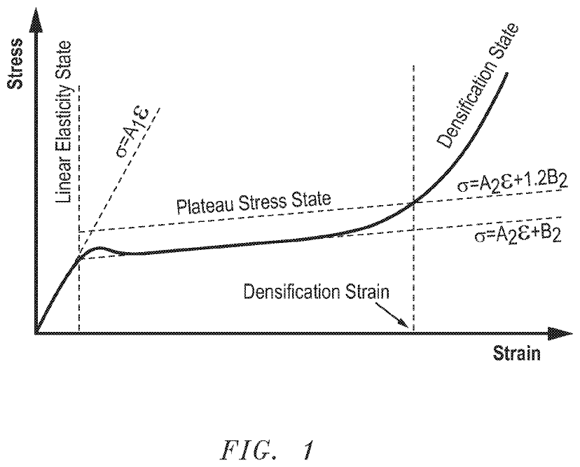

As used herein, the term “densification strain” refers to the compressive strain at the onset of densification of the sample. For purposes of embodiments described herein, densification strain may be determined by 1) measuring the height (H) of a sample of the compressible sheet using a dial foot applying a force of 0.8±0.2 N, 2) performing a compression test on the sample by placing the sample in the lower platen in a compression tester, bringing the platen down into contact with the sample at 50 mm per minute to a force of 0.05 N, compressing the sample at 50 mm per minute down to 90% of its thickness, and recording the force and displacement of the compression tester, 3) calculating the stress in kilo Pascals (kPa) according to the following equation: Stress=F/(L×W)×10³, where F is the force recorded by compression tester in N, L is the length of the sample in mm and W is the width of the sample in mm, 4) calculating the strain in percent (%) according to the following equation: Strain=(d−H)/H×10², where d is the relative displacement of the compression tester from the initial contact position in mm and H is the height of the sample in mm, 5) plotting a compression curve for Stress vs. Strain based on the results from the compression test, 6) identifying the plateau stress state along the compression curve, 7) adjusting a linear regression to match the plateau stress state along the compression curve where the linear regression is defined by the following equation: α=A₂B+B₂, and 8) calculating the densification strain according to the following equation: Densification Strain=(Stress−1.2×B₂)/A₂×100, where A₂ is the positive constant in kPa determined in step 7 above, B2 is the constant in kPa determined in step 7 above and Stress corresponds to the stress in kPa calculated in step 5 above, as measured during the compression test. For purposes of illustration, FIG. 1 includes a sample compression curve from a compression test as described herein. As shown in FIG. 1, the plateau stress state used in step 6 above can be identified as the portion of the curve between a first portion know as the linear elasticity state and a final portion known as the densification state.

Embodiments described herein are generally directed to a compressible sheet that may include a structured core.

According to particular embodiments described herein, the structured core may include an elastomer material. According to still other embodiments, the elastomer material may include thermoplastic material. According to still other embodiments, the thermoplastic material may include thermoplastic elastomers, such as cross-linkable elastomeric polymers of natural or synthetic origin. According to still other embodiments, elastomers may include silicone, natural rubber, urethane, olefinic elastomer, diene elastomer, blend of olefinic and diene elastomer, fluoroelastomer, perfluoroelastomer, or any combination thereof. According to still other embodiments, the elastomer may include polyurethane.

According to certain embodiments, the structured core may be a single layer component. According to still other embodiments, the structured core may include a multi-layer composite. According to still other embodiments, the structured core may be a multi-layer composite. According to yet other embodiments, the multi-layer composite may include at least a first core layer and a second core layer. According to still other embodiments, the first core layer may be distinct from the second core layer. According to yet other embodiments, the first core layer and the second core layer may include different materials from each other.

According to certain embodiments, the compressible sheet may have a particular average height. For example, the compressible sheet may have an average height of not greater than about 5 mm, such as, not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or even not greater than about 0.2 mm. According to yet other embodiments, the compressible sheet may have an average height of at least about 0.01 mm, such as, at least about 0.02 mm or at least about 0.03 mm or at least about 0.04 mm or at least about 0.05 mm or at least about 0.06 mm or at least about 0.07 mm or at least about 0.08 mm or at least about 0.09 mm or even at least about 0.1 mm. It will be appreciated that the average height of the compressible sheet may be any value between any of the minimum and maximum values noted above. It will be further appreciated that the average height of the compressible sheet may be any value within a range between any of the minimum and maximum values noted above.

According to still other embodiments, the compressible sheet may have a particular surface density. For example, the compressible sheet may have a surface density of at least about 50 g/m², such as, at least about 60 g/m² or at least about 70 g/m² or at least about 80 g/m² or at least about 90 g/m² or at least about 100 g/m² or at least about 110 g/m² or at least about 120 g/m² or at least about 130 g/m² or at least about 140 g/m² or at least about 150 g/m² or at least about 160 g/m² or at least about 170 g/m² or at least about 180 g/m² or at least about 190 g/m² or at least about 200 g/m² or at least about 210 g/m² or at least about 220 g/m² or at least about 230 g/m² or at least about 240 g/m² or at least about 250 g/m² or at least about 260 g/m² or at least about 270 g/m² or at least about 280 g/m² or at least about 290 or even at least about 300 g/m². According to yet other embodiments, the compressible sheet may have a surface density of not greater than about 600 g/m², such as, not greater than about 590 g/m² or not greater than about 580 g/m² or not greater than about 570 g/m² or not greater than about 560 g/m² or not greater than about 550 g/m² or not greater than about 540 g/m² or not greater than about 530 g/m² or not greater than about 520 g/m² or not greater than about 510 g/m² or not greater than about 500 g/m² or not greater than about 490 g/m² or not greater than about 480 g/m² or not greater than about 470 g/m² or not greater than about 460 g/m² or not greater than about 450 g/m² or not greater than about 440 g/m² or not greater than about 430 g/m² or not greater than about 420 g/m² or not greater than about 410 g/m² or even not greater than about 400 g/m². It will be appreciated that the surface density of the compressible sheet may be any value between any of the minimum and maximum values noted above. It will be further appreciated that the surface density of the compressible sheet may be any value within a range between any of the minimum and maximum values noted above.

According to still other embodiments, the compressible sheet may have a particular volume density. For example, the volume density of the compressible sheet may be at least about 10 g/L, such as, at least about 20 g/L or at least about 30 g/L or at least about 40 g/L or at least about 50 g/L or at least about 60 g/L or at least about 70 g/L or at least about 80 g/L or even at least about 90 g/L. According to yet other embodiments, the volume density of the compressible sheet may be not greater than about 500 g/L or not greater than about 400 g/L or not greater than about 300 g/L or not greater than about 200 g/L or even not greater than about 100 g/L. It will be appreciated that the volume density of the compressible sheet may be any value between any of the minimum and maximum values noted above. It will be further appreciated that the volume density of the compressible sheet may be any value within a range between any of the minimum and maximum values noted above.

According to yet other embodiments, the compressible sheet may have a particular densification strain. For example, the compressible sheet may have a densification strain of at least about 40%, such as, at least about 41% or at least about 42% or at least about 43% or at least about 44% or at least about 45% or at least about 46% or at least about 47% or at least about 48% or at least about 49% or at least about 50% or at least about 51% or at least about 52% or at least about 53% or at least about 54% or at least about 55% or at least about 56% or at least about 57% or at least about 58% or at least about 59% or at least about 60% or at least about 61% or at least about 62% or at least about 63% or at least about 64% or at least about 65% or at least about 66% or at least about 67% or at least about 68% or at least about 69% or at least about 70% or at least about 71% or at least about 72% or at least about 73% or at least about 74% or at least about 75% or at least about 76% or at least about 77% or at least about 78% or at least about 79% or at least about 80% or at least about 81% or at least about 82% or at least about 83% or at least about 84% or at least about 85% or at least about 86% or at least about 87% or at least about 88% or at least about 89% or even at least about 90%. According to still other embodiments, the compressible sheet may have a densification strain of not greater than about 99%. It will be appreciated that the densification strain may be any value between any of the minimum and maximum values noted above. It will be further appreciated that the densification strain of the compressible sheet may be any value within a range between any of the minimum and maximum values noted above.

According to certain embodiments the structured core of the compressible sheet may have a particular structure.

For example, according to certain embodiments, the structured core may have a cellular lattice structure. According to certain embodiments described herein, the cellular lattice structure of the structured core may include a lattice-type pattern of support walls orthogonal to a longitudinal plane of the structured core. According to still other embodiments, the cellular lattice structure of the structured core may include a lattice-type pattern of support walls orthogonal to a longitudinal plane of the compressible sheet. According to still other embodiments, the cellular lattice structure of the structured core may include a regular lattice-type pattern of cells defined by the support walls.

According to still other embodiments, the cellular lattice structure of the structured core may include a regular lattice-type pattern of open cells defined by the support walls. According to yet other embodiments, the cellular lattice structure of the structured core may include a regular lattice-type pattern of closed cells defined by the support walls. According to yet other embodiments, the cellular lattice structure of the structured core may include a regular lattice-type pattern of open cells and closed cells defined by the support walls. According to still other embodiments, the cellular lattice structure of the structured core may consist of a regular lattice-type pattern of open cells defined by the support walls. According to yet other embodiments, the cellular lattice structure of the structured core may consist of a regular lattice-type pattern of closed cells defined by the support walls. According to yet other embodiments, the cellular lattice structure of the structured core may consist of a regular lattice-type pattern of open cells and closed cells defined by the support walls.

According to yet other embodiments, the cells of the regular lattice-type pattern of cells may have a particular geometric shape. According to certain embodiments, the cells of the regular lattice-type pattern of cells may have a circular shape. According to yet other embodiments, the cells of the regular lattice-type pattern of cells may have a triangular shape. According to still other embodiments, the cells of the regular lattice-type pattern of cells may have a quadrilateral shape. According to other embodiments, the cells of the regular lattice-type pattern of cells may have a pentagonal shape. According to yet other embodiments, the cells of the regular lattice-type pattern of cells may have a hexagonal shape.

According to still other embodiments, the support walls of the cellular lattice structure of the structured core may have a non-uniform thickness. According to still other embodiments, the support walls of the cellular lattice structure of the structured core may have a uniform thickness. According to still other embodiments, the support walls of the cellular lattice structure of the structured core may have a particular average thickness CLS_{T}.

According to still other embodiments, the support walls of the cellular lattice structure of the structured core may have a non-uniform height. According to still other embodiments, the support walls of the cellular lattice structure of the structured core may have a uniform height. According to still other embodiments, the support walls of the cellular lattice structure of the structured core may have a particular average height CLS_{H}.

According to particular embodiments, the support walls of the cellular lattice structure of the structured core may have a particular aspect ratio CLS_{H}/CLS_{T}. For example, the aspect ratio CLS_{H}/CLS_{T} of the support walls may be at least about 1, such as, at least about 2 or at least about 3 or even at least about 4. According to still other embodiments, aspect ratio CLS_{H}/CLS_{T} may be not greater than about 30, such as, not greater than about 28 or not greater than about 26 or not greater than about 24 or not greater than about 22 or not greater than about 20 or not greater than about 18 or not greater than about 16 or not greater than about 14 or not greater than about 12 or even not greater than about 10. It will be appreciated that the aspect ratio CLS_{H}/CLS_{T} of the support walls may be any value between any of the minimum and maximum values noted above. It will be further appreciated that the aspect ratio CLS_{H}/CLS_{T} of the support walls may be any value within a range between any of the minimum and maximum values noted above.

According to still other embodiments, the average height CLS_{H} of the support walls may be not greater than about 5 mm, such as, not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or even not greater than about 0.2 mm. According to still other embodiments, the average height CLS_{H} of the support walls may be at least about 0.01 mm, such as, at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm. It will be appreciated that the average height CLS_{H} of the support walls may be any value between any of the minimum and maximum values noted above. It will be further appreciated that the average height CLS_{H} of the support walls may be any value within a range between any of the minimum and maximum values noted above.

According to still other embodiments, the average thickness CLS_{T} of the support walls may be not greater than about 1 mm, such as, not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1 mm or not greater than about 0.09 mm or not greater than about 0.08 mm or not greater than about 0.07 mm or not greater than about 0.06 mm or even not greater than about 0.05 mm. According to yet other embodiments, the average thickness CLS_{T} of the support walls may be at least about 0.001 mm, such as, at least about 0.005 mm or at least about 0.01 mm or at least about 0.015 mm or at least about 0.02 mm or at least about 0.025 mm or at least about 0.03 mm or at least about 0.035 mm or at least about 0.04 mm or even at least about 0.045 mm. It will be appreciated that the average thickness CLS_{T} of the support walls may be any value between any of the minimum and maximum values noted above. It will be further appreciated that the average thickness CLS_{T} of the support walls may be any value within a range between any of the minimum and maximum values noted above.

According to still other embodiments, the individual cells of the cellular lattice structure of the structured core may be made up of individual support wall units. According to still other embodiments, the individual support wall units that make up the individual cells of the cellular lattice structure of the structured core may have a particular average length CLS_{WL}. For example, the average length CLS_{WL} of the support wall units may be at least about 0.01 mm, such as, at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 1 mm or at least about 2 mm or at least about 3 mm or at least about 4 mm or at least about 5 mm or at least about 6 mm. According to still other embodiments, the average length CLS_{WL} of the support wall units may be not greater than about 15 mm, such as, not greater than about 14 mm or not greater than about 13 mm or not greater than about 12 mm or not greater than about 11 mm or even not greater than about 10 mm. It will be appreciated that the average length CLS_{WL} of the support wall units may be any value between any of the minimum and maximum values noted above. It will be further appreciated that the average length CLS_{WL} of the support wall units may be any value within a range between any of the minimum and maximum values noted above.

According to yet other embodiments, the cellular lattice structure of the structured core may have a particular volume density. For example, the volume density of the cellular lattice structure may be at least about 10 g/L, such as, at least about 20 g/L or at least about 30 g/L or at least about 40 g/L or at least about 50 g/L or at least about 60 g/L or at least about 70 g/L or at least about 80 g/L or even at least about 90 g/L. According to yet other embodiments, the volume density of the cellular lattice structure may be not greater than about 500 g/L or not greater than about 400 g/L or not greater than about 300 g/L or not greater than about 200 g/L or not greater than about 100 g/L. It will be appreciated that the volume density of the cellular lattice structure may be any value between any of the minimum and maximum values noted above. It will be further appreciated that the volume density of the cellular lattice structure may be any value within a range between any of the minimum and maximum values noted above.

According to yet other embodiments, the cellular lattice structure of the structured core may have a particular out of plane compressive stress measured according to ASTM D1667 at a 40% strain. For example, the out of plane compressive stress of the cellular lattice structure may be at least about 10 kPa, such as, at least about 15 kPa or at least about 20 kPa or at least about 25 kPa or at least about 30 kPa or at least about 35 kPa or at least about 40 kPa or even at least about 45 kPa. According to yet other embodiments, the out of plane compressive stress of the cellular lattice structure may be not greater than about 500 kPa, such as, not greater than about 450 kPa or not greater than about 400 kPa or not greater than about 350 kPa or not greater than about 300 kPa or not greater than about 290 kPa or not greater than about 280 kPa or not greater than about 270 kPa or not greater than about 260 kPa or not greater than about 250 kPa or not greater than about 240 kPa or not greater than about 230 kPa or not greater than about 220 kPa or not greater than about 210 kPa or not greater than about 200 kPa. It will be appreciated that the out of plane compressive stress of the cellular lattice structure may be any value between any of the minimum and maximum values noted above. It will be further appreciated that the out of plane compressive stress of the cellular lattice structure may be any value within a range between any of the minimum and maximum values noted above.

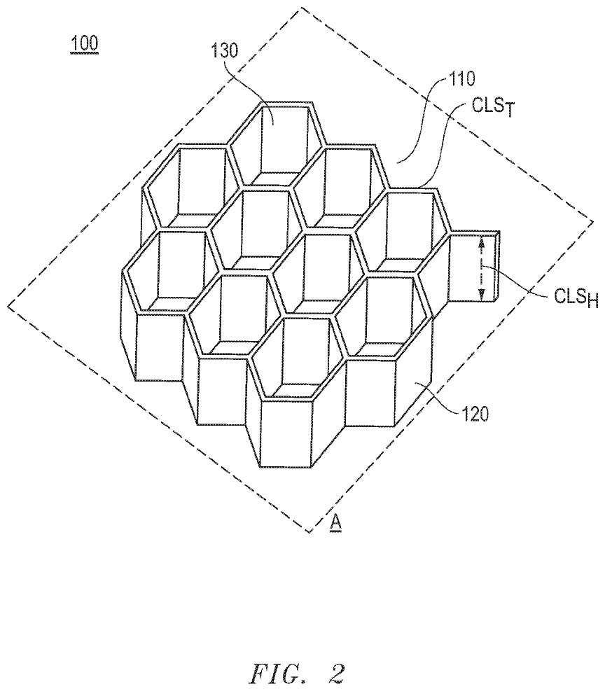

For purposes of illustration, FIG. 2 shows a compressible sheet having a structured core with a lattice structure according to embodiments described herein. As shown in FIG. 2, a compressible sheet 100 may include a structured core 110. The structured core 110 may have cellular lattice structure. The cellular lattice structure of the structured core 100 may include a lattice-type pattern of support walls 120 orthogonal to a longitudinal plan A of the compressible sheet 100. The support walls 120 may define a pattern of open cells 130 have a hexagonal shape. The support walls 120 may have a uniform thickness and a uniform height. As shown in FIG. 2, the support wall 120 may have an average thickness CLS_{T} and an average height CLS_{H}.

According to still other embodiments the structured core of the compressible sheet may have a corrugated wave structure. According to certain embodiments, the corrugated wave structure may be a sheet structure undulating in an oscillating wave pattern of successive wave-troughs and wave-crests. According to particular embodiments, the wave-troughs and the wave-crests of the oscillating wave pattern may run a width of the structured core.

According to still other embodiments, the wave-troughs and the wave-crests of the oscillating wave pattern may have a uniform cross-sectional shape that runs a width of the structured core. According to certain embodiments, the uniform cross-sectional shape may be a generally trapezoidal shape. According to other embodiments, the uniform cross-sectional shape may be a generally triangular shape. According to still other embodiments, the uniform cross-sectional shape may be a generally rectangular shape. According to yet other embodiments, the uniform cross-sectional shape may be a generally trapezoidal shape.

According to still other embodiments, the wave-troughs and the wave-crests of the oscillating wave pattern of the structured core may have a non-uniform thickness. According to still other embodiments, the wave-troughs and the wave-crests of the oscillating wave pattern of the structured core may have a uniform thickness. According to still other embodiments, the wave-troughs and the wave-crests of the oscillating wave pattern of the structured core may have a particular average thickness CWS_{T}.

According to still other embodiments, the wave-troughs and the wave-crests of the oscillating wave pattern of the structured core may have a non-uniform height. According to still other embodiments, the wave-troughs and the wave-crests of the oscillating wave pattern of the structured core may have a uniform height. According to still other embodiments, the wave-troughs and the wave-crests of the oscillating wave pattern of the structured core may have a particular average height CWS_{H}.

According to still other embodiments, the wave-troughs and the wave-crests of the oscillating wave pattern of the structured core may have a non-uniform period. According to still other embodiments, the wave-troughs and the wave-crests of the oscillating wave pattern of the structured core may have a uniform period. According to still other embodiments, the wave-troughs and the wave-crests of the oscillating wave pattern of the structured core may have a particular average period CWS_{P}.

According to particular embodiments, the wave-troughs and the wave-crests of the oscillating wave pattern of the structured core may have a particular aspect ratio CWS_{H}/CWS_{T}. For example, the aspect ratio CWS_{H}/CWS_{T} of the wave-troughs and the wave-crests of the oscillating wave pattern may be at least about 1, such as, at least about 2 or at least about 3 or even at least about 4. According to still other embodiments, aspect ratio CWS_{H}/CWS_{T} may be not greater than about 30, such as, not greater than about 28 or not greater than about 26 or not greater than about 24 or not greater than about 22 or not greater than about 20 or not greater than about 18 or not greater than about 16 or not greater than about 14 or not greater than about 12 or even not greater than about 10. It will be appreciated that the aspect ratio CWS_{H}/CWS_{T} of the wave-troughs and the wave-crests of the oscillating wave pattern may be any value between any of the minimum and maximum values noted above. It will be further appreciated that the aspect ratio CWS_{H}/CWS_{T} of the wave-troughs and the wave-crests of the oscillating wave pattern may be any value within a range between any of the minimum and maximum values noted above.

According to still other embodiments, the average height CWS_{H} of the wave-troughs and the wave crests of the oscillating wave pattern may be not greater than about 5 mm, such as, not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or even not greater than about 0.2 mm. According to still other embodiments, the average height CWS_{H} of the wave-troughs and the wave crests of the oscillating wave pattern may be at least about 0.01 mm, such as, at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm. It will be appreciated that the average height CWS_{H} of the wave-troughs and the wave crests of the oscillating wave pattern may be any value between any of the minimum and maximum values noted above. It will be further appreciated that the average height CWS_{H} of the wave-troughs and the wave crests of the oscillating wave pattern may be any value within a range between any of the minimum and maximum values noted above.

According to still other embodiments, the average thickness CWS_{T} of the wave-troughs and the wave crests of the oscillating wave pattern may be not greater than about 1 mm, such as, not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1 mm or not greater than about 0.09 mm or not greater than about 0.08 mm or not greater than about 0.07 mm or not greater than about 0.06 mm or even not greater than about 0.05 mm According to yet other embodiments, the average thickness CWS_{T} of the wave-troughs and the wave crests of the oscillating wave pattern may be at least about 0.001 mm, such as, at least about 0.005 mm or at least about 0.01 mm or at least about 0.015 mm or at least about 0.02 mm or at least about 0.025 mm or at least about 0.03 mm or at least about 0.035 mm or at least about 0.04 mm or even at least about 0.045 mm. It will be appreciated that the average thickness CWS_{T} of the wave-troughs and the wave crests of the oscillating wave pattern may be any value between any of the minimum and maximum values noted above. It will be further appreciated that the average thickness CWS_{T} of the wave-troughs and the wave crests of the oscillating wave pattern may be any value within a range between any of the minimum and maximum values noted above.

According to still other embodiments, the period CWS_{P} of the wave-troughs and the wave crests of the oscillating wave pattern may be at least about 0.01 mm, such as, at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 1 mm or at least about 2 mm or at least about 3 mm or at least about 4 mm or at least about 5 mm or at least about 6 mm. According to still other embodiments, the period CWS_{P} of the wave-troughs and the wave crests of the oscillating wave pattern may be not greater than about 15 mm, such as, not greater than about 14 mm or not greater than about 13 mm or not greater than about 12 mm or not greater than about 11 mm or even not greater than about 10 mm. It will be appreciated that the period CWS_{P} of the wave-troughs and the wave crests of the oscillating wave pattern may be any value between any of the minimum and maximum values noted above. It will be further appreciated that the period CWS_{P} of the wave-troughs and the wave crests of the oscillating wave pattern may be any value within a range between any of the minimum and maximum values noted above.

According to still other embodiments, the corrugated wave structure of the structured core may have a particular surface density. For example, the corrugated wave structure of the structured core may have a surface density of at least about 50 g/m², such as, at least about 60 g/m² or at least about 70 g/m² or at least about 80 g/m² or at least about 90 g/m² or at least about 100 g/m² or at least about 110 g/m² or at least about 120 g/m² or at least about 130 g/m² or at least about 140 g/m² or at least about 150 g/m² or at least about 160 g/m² or at least about 170 g/m² or at least about 180 g/m² or at least about 190 g/m² or at least about 200 g/m² or at least about 210 g/m² or at least about 220 g/m² or at least about 230 g/m² or at least about 240 g/m² or at least about 250 g/m² or at least about 260 g/m² or at least about 270 g/m² or at least about 280 g/m² or at least about 290 or even at least about 300 g/m². According to yet other embodiments, the corrugated wave structure of the structured core may have a surface density of not greater than about 600 g/m², such as, not greater than about 590 g/m² or not greater than about 580 g/m² or not greater than about 570 g/m² or not greater than about 560 g/m² or not greater than about 550 g/m² or not greater than about 540 g/m² or not greater than about 530 g/m² or not greater than about 520 g/m² or not greater than about 510 g/m² or not greater than about 500 g/m² or not greater than about 490 g/m² or not greater than about 480 g/m² or not greater than about 470 g/m² or not greater than about 460 g/m² or not greater than about 450 g/m² or not greater than about 440 g/m² or not greater than about 430 g/m² or not greater than about 420 g/m² or not greater than about 410 g/m² or even not greater than about 400 g/m². It will be appreciated that the surface density of the corrugated wave structure of the structured core may be any value between any of the minimum and maximum values noted above. It will be further appreciated that the surface density of the corrugated wave structure of the structured core may be any value within a range between any of the minimum and maximum values noted above.

According to yet other embodiments, the corrugated wave structure of the structured core may have a particular out of plane compressive stress measured according to ASTM D1667 at a 40% strain. For example, the out of plane compressive stress of the corrugated wave structure may be at least about 10 kPa, such as, at least about 15 kPa or at least about 20 kPa or at least about 25 kPa or at least about 30 kPa or at least about 35 kPa or at least about 40 kPa or even at least about 45 kPa. According to yet other embodiments, the out of plane compressive stress of the corrugated wave structure may be not greater than about 500 kPa, such as, not greater than about 450 kPa or not greater than about 400 kPa or not greater than about 350 kPa or not greater than about 300 kPa or not greater than about 290 kPa or not greater than about 280 kPa or not greater than about 270 kPa or not greater than about 260 kPa or not greater than about 250 kPa or not greater than about 240 kPa or not greater than about 230 kPa or not greater than about 220 kPa or not greater than about 210 kPa or not greater than about 200 kPa. It will be appreciated that the out of plane compressive stress of the corrugated wave structure may be any value between any of the minimum and maximum values noted above. It will be further appreciated that the out of plane compressive stress of the corrugated wave structure may be any value within a range between any of the minimum and maximum values noted above.

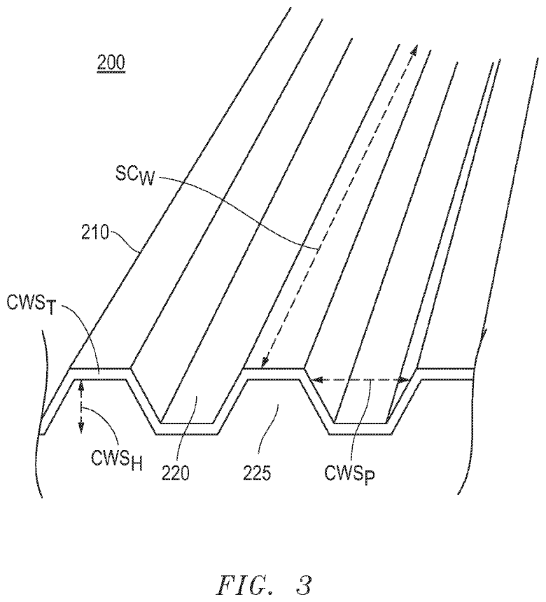

For purposes of illustration, FIG. 3 shows a compressible sheet having a structured core with a corrugated wave structure according to embodiments described herein. As shown in FIG. 3, a compressible sheet 200 may include a structured core 210. The structured core 210 may have corrugated wave structure. The corrugated wave structure of the structured core 210 may include a sheet structure undulating in an oscillating wave pattern of successive wave-troughs 220 and wave-crests 225. The wave-troughs 220 and the wave-crests 225 of the oscillating wave pattern may run a width SC_{W} of the structured core 210. The wave-troughs 220 and the wave-crests 225 of the oscillating wave pattern may have a uniform cross-sectional shape 230 that runs a width of the structured core 210. The uniform cross-sectional shape 230 may be a generally trapezoidal shape. The wave-troughs 220 and the wave-crests 225 of the oscillating wave pattern may have a uniform thickness and a uniform height. As shown in FIG. 3, the wave-troughs 220 and the wave-crests 225 of the oscillating wave pattern may have average thickness CWS_{T}, an average height CWS_{H}, and a period CWS_{P}.

According to still other embodiments the structured core of the compressible sheet may have a corrugated beam structure. According to certain embodiments, the corrugated beam structure may include a plurality of support walls orthogonal to a longitudinal plane of the compressible sheet. According to still other embodiments, the support walls may be parallel to each other. According to still other embodiments, the support walls may further run a width of the structured core.

According to still other embodiments, the support walls of the corrugated beam structure of the structured core may have a non-uniform thickness. According to still other embodiments, the support walls of the corrugated beam structure of the structured core may have a uniform thickness. According to still other embodiments, the support walls of the corrugated beam structure of the structured core may have a particular average thickness CBS_{T}.

According to still other embodiments, the support walls of the corrugated beam structure of the structured core may have a non-uniform height. According to still other embodiments, the support walls of the corrugated beam structure of the structured core may have a uniform height. According to still other embodiments, the support walls of the corrugated beam structure of the structured core may have a particular average height CBS_{H}.

According to particular embodiments, the support walls of the corrugated beam structure of the structured core may have a particular aspect ratio CBS_{H}/CBS_{T}. For example, the aspect ratio CBS_{H}/CBS_{T} of the support walls of the corrugated beam structure may be at least about 1, such as, at least about 2 or at least about 3 or even at least about 4. According to still other embodiments, aspect ratio CBS_{H}/CBS_{T} may be not greater than about 30, such as, not greater than about 28 or not greater than about 26 or not greater than about 24 or not greater than about 22 or not greater than about 20 or not greater than about 18 or not greater than about 16 or not greater than about 14 or not greater than about 12 or even not greater than about 10. It will be appreciated that the aspect ratio CBS_{H}/CBS_{T} of the support walls of the corrugated beam structure may be any value between any of the minimum and maximum values noted above. It will be further appreciated that the aspect ratio CBS_{H}/CBS_{T} of the support walls of the corrugated beam structure may be any value within a range between any of the minimum and maximum values noted above.

According to still other embodiments, the average height CBS_{H} of the support walls of the corrugated beam structure may be not greater than about 5 mm, such as, not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or even not greater than about 0.2 mm. According to still other embodiments, the average height CBS_{H} of the support walls of the corrugated beam structure may be at least about 0.01 mm, such as, at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm. It will be appreciated that the average height CBS_{H} of the support walls of the corrugated beam structure may be any value between any of the minimum and maximum values noted above. It will be further appreciated that the average height CBS_{H} of the support walls of the corrugated beam structure may be any value within a range between any of the minimum and maximum values noted above.

According to still other embodiments, the average thickness CBS_{T} of the support walls of the corrugated beam structure may be not greater than about 1 mm, such as, not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1 mm or not greater than about 0.09 mm or not greater than about 0.08 mm or not greater than about 0.07 mm or not greater than about 0.06 mm or even not greater than about 0.05 mm. According to yet other embodiments, the average thickness CBS_{T} of the support walls of the corrugated beam structure may be at least about 0.001 mm, such as, at least about 0.005 mm or at least about 0.01 mm or at least about 0.015 mm or at least about 0.02 mm or at least about 0.025 mm or at least about 0.03 mm or at least about 0.035 mm or at least about 0.04 mm or even at least about 0.045 mm. It will be appreciated that the average thickness CBS_{T} of the support walls of the corrugated beam structure may be any value between any of the minimum and maximum values noted above. It will be further appreciated that the average thickness CBS_{T} of the support walls of the corrugated beam structure may be any value within a range between any of the minimum and maximum values noted above.

According to still other embodiments, the corrugated beam structure of the structured core may have a particular surface density. For example, the corrugated beam structure of the structured core may have a surface density of at least about 50 g/m², such as, at least about 60 g/m² or at least about 70 g/m² or at least about 80 g/m² or at least about 90 g/m² or at least about 100 g/m² or at least about 110 g/m² or at least about 120 g/m² or at least about 130 g/m² or at least about 140 g/m² or at least about 150 g/m² or at least about 160 g/m² or at least about 170 g/m² or at least about 180 g/m² or at least about 190 g/m² or at least about 200 g/m² or at least about 210 g/m² or at least about 220 g/m² or at least about 230 g/m² or at least about 240 g/m² or at least about 250 g/m² or at least about 260 g/m² or at least about 270 g/m² or at least about 280 g/m² or at least about 290 or even at least about 300 g/m². According to yet other embodiments, the corrugated beam structure of the structured core may have a surface density of not greater than about 600 g/m², such as, not greater than about 590 g/m² or not greater than about 580 g/m² or not greater than about 570 g/m² or not greater than about 560 g/m² or not greater than about 550 g/m² or not greater than about 540 g/m² or not greater than about 530 g/m² or not greater than about 520 g/m² or not greater than about 510 g/m² or not greater than about 500 g/m² or not greater than about 490 g/m² or not greater than about 480 g/m² or not greater than about 470 g/m² or not greater than about 460 g/m² or not greater than about 450 g/m² or not greater than about 440 g/m² or not greater than about 430 g/m² or not greater than about 420 g/m² or not greater than about 410 g/m² or even not greater than about 400 g/m². It will be appreciated that the surface density of the corrugated beam structure of the structured core may be any value between any of the minimum and maximum values noted above. It will be further appreciated that the surface density of the corrugated beam structure of the structured core may be any value within a range between any of the minimum and maximum values noted above.

According to yet other embodiments, the corrugated beam structure of the structured core may have a particular out of plane compressive stress measured according to ASTM D1667 at a 40% strain. For example, the out of plane compressive stress of the corrugated beam structure may be at least about 10 kPa, such as, at least about 15 kPa or at least about 20 kPa or at least about 25 kPa or at least about 30 kPa or at least about 35 kPa or at least about 40 kPa or even at least about 45 kPa. According to yet other embodiments, the out of plane compressive stress of the corrugated beam structure may be not greater than about 500 kPa, such as, not greater than about 450 kPa or not greater than about 400 kPa or not greater than about 350 kPa or not greater than about 300 kPa or not greater than about 290 kPa or not greater than about 280 kPa or not greater than about 270 kPa or not greater than about 260 kPa or not greater than about 250 kPa or not greater than about 240 kPa or not greater than about 230 kPa or not greater than about 220 kPa or not greater than about 210 kPa or not greater than about 200 kPa. It will be appreciated that the out of plane compressive stress of the corrugated beam structure may be any value between any of the minimum and maximum values noted above. It will be further appreciated that the out of plane compressive stress of the corrugated beam structure may be any value within a range between any of the minimum and maximum values noted above.

For purposes of illustration, FIG. 4 shows a compressible sheet having a structured core with a corrugated beam structure according to embodiments described herein. As shown in FIG. 4, a compressible sheet 300 may include a structured core 310. The structured core 310 may have corrugated beam structure. The corrugated beam structure of the structured core 310 may include support wall 320. The support wall 320 may be parallel to each other. The support wall 320 may run a width SC_{W} of the structured core 310. The support walls 320 may have a uniform thickness and a uniform height. As shown in FIG. 4, the support wall 320 may have an average thickness CBS_{T} and an average height CBS_{H}.

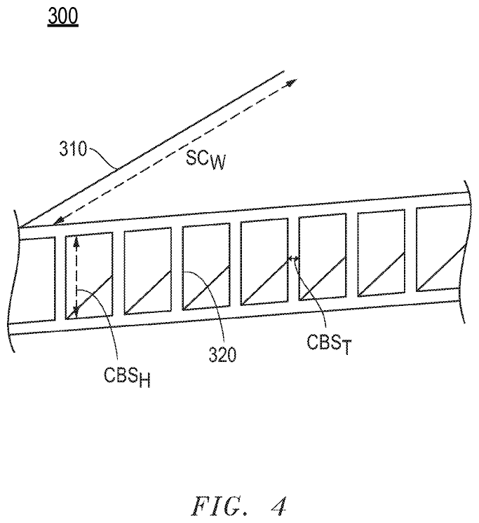

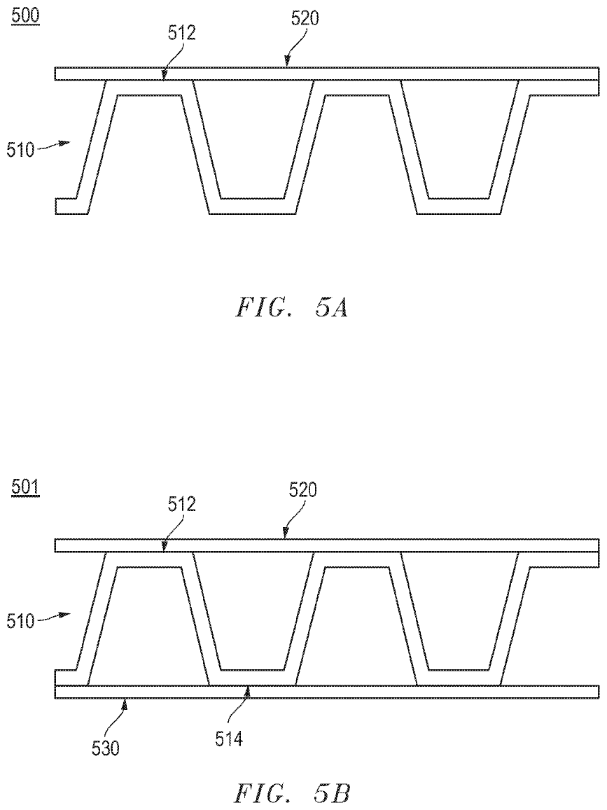

According to yet other embodiments described herein, a compressible sheet may further include a first skin-layer adjacent to a first surface of the structured core. For purposes of illustration, FIG. 5a shows a cross-sectional view of a compressible sheet 500 having a structured core 510 with a corrugated beam structure and a first skin-layer 520 adjacent to a first surface 512 of the structured core 510. It will be appreciated that the first skin-layer 520 may be used in a compressible sheet with a structured core having any of the structures described herein.

According to still other embodiments described herein, a compressible sheet may further include a first skin-layer adjacent to a first surface of the structured core and a second skin-layer adjacent to a second surface of the structured core that is opposite of and parallel to the first surface of the structured core. For purposes of illustration, FIG. 5b shows a cross-sectional view of a compressible sheet 501 having a structured core 510 with a corrugated beam structure, a first skin-layer 520 adjacent to a first surface 512 of the structured core 510, and a second skin-layer 530 adjacent to a second surface 514 of the structured core 510 where the second surface 514 is opposite of and parallel to the first surface 512 of the structured core 510. FIG. 5c shows an alternative view of the compressible sheet 501. It will be appreciated that the first skin-layer and the second skin-layer may be used in a compressible sheet with a structured core having any of the structures described herein.

According to certain embodiments, the first and/or second skin-layer may be any desirable material, for example, aluminum.

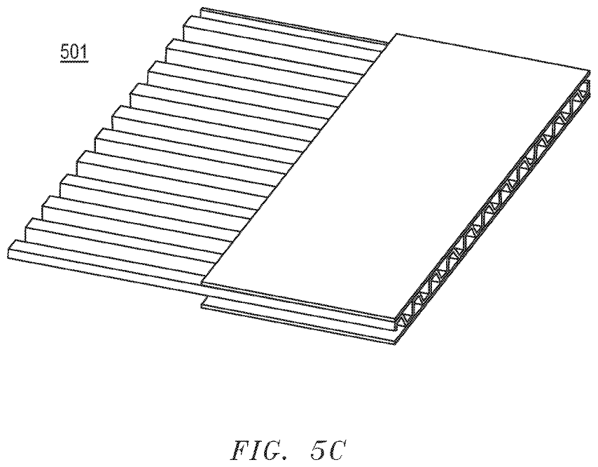

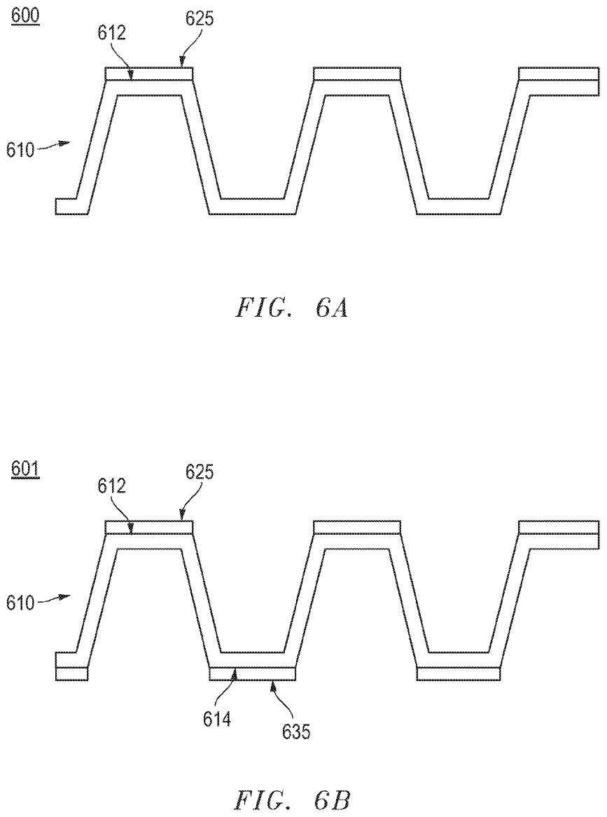

According to yet other embodiments described herein, a compressible sheet may further include a first adhesive on a first surface of the structured core. For purposes of illustration, FIG. 6a shows a compressible sheet 600 having a structured core 610 with a corrugated beam structure and a first adhesive 625 adjacent to a first surface 612 of the structured core 610. It will be appreciated that the first adhesive 625 may be used in a compressible sheet with a structured core having any of the structures described herein. It will be further appreciated that, depending on the structure of the structured core, the adhesive layer may be discontinuous (i.e., as shown in FIG. 6a) or may be a continuous layer.

According to still other embodiments described herein, a compressible sheet may further include a first adhesive adjacent to a first surface of the structured core and a second adhesive adjacent to a second surface of the structured core that is opposite of and parallel to the first surface of the structured core. For purposes of illustration, FIG. 6b shows a compressible sheet 601 having a structured core 610 with a corrugated beam structure, a first adhesive 625 adjacent to a first surface 612 of the structured core 610, and a second adhesive 635 adjacent to a second surface 614 of the structured core 610 where the second surface 614 is opposite of and parallel to the first surface 612 of the structured core 610. It will be appreciated that the first adhesive and the second adhesive may be used in a compressible sheet with a structured core having any of the structures described herein. It will be further appreciated that, depending on the structure of the structured core, the adhesive layers may be discontinuous (i.e., as shown in FIG. 6b) or may be continuous layers.

According to still other embodiments described herein, a compressible sheet may include any combination of an adhesive layer and a skin layer on any surface of the structured core. Further, the adhesive layer and the skin layer may be applied in any desirable order.

Further embodiments described herein are generally directed to a battery pack spacer. According to particular embodiments, the battery pack spacer may include a compressible sheet that may include a structured core. It will be appreciated that the compressible sheet included in the battery pack spacer may be described as having any of the components or characteristics of any other embodiment of the compressible sheet described herein. It will be further appreciated that the structured core of the compressible sheet included in the battery pack spacer may be described as having any of the components or characteristics of any other embodiment of the structured core of the compressible sheet described herein.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A battery pack spacer comprising a compressible sheet, wherein the compressible sheet comprises a structured core; wherein the structured core comprises an elastomer material; and wherein the compressible sheet has an average height of not greater than about 5 mm.

Embodiment 2. A battery pack spacer comprising a compressible sheet, wherein the compressible sheet comprises a structured core; wherein the structured core comprises an elastomer material; and wherein the compressible sheet comprises a surface density of not greater than about 500 g/m².

Embodiment 3. A battery pack spacer comprising a compressible sheet, wherein the compressible sheet comprises a structured core; wherein the structured core comprises an elastomer material; and wherein the compressible sheet comprises a densification strain of at least about 40%.

Embodiment 4. The battery pack spacer of any one of embodiments 1, 2, and 3, wherein the elastomer material comprises thermoplastic material, wherein the thermoplastic material comprises thermoplastic elastomers, wherein the elastomers comprise cross-linkable elastomeric polymers of natural or synthetic origin, wherein the elastomers comprise silicone, natural rubber, urethane, olefinic elastomer, diene elastomer, blend of olefinic or diene elastomer, fluoroelastomer, perfluoroelastomer, or any combination thereof, wherein the elastomer comprises polyurethane.

Embodiment 5. The battery pack spacer of any one of embodiments 1, 2, and 3, wherein the compressible sheet has an average height of not greater than about 5 mm or not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or not greater than about 0.2 mm.

Embodiment 6. The battery pack spacer of any one of embodiments 1, 2, and 3, wherein the compressible sheet has an average height of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm.

Embodiment 7. The battery pack spacer of any one of embodiments 1, 2, and 3, wherein the compressible sheet comprises a surface density of not greater than about 600 g/m² or not greater than about 590 g/m² or not greater than about 580 g/m² or not greater than about 570 g/m² or not greater than about 560 g/m² or not greater than about 550 g/m² or not greater than about 540 g/m² or not greater than about 530 g/m² or not greater than about 520 g/m² or not greater than about 510 g/m² or not greater than about 500 g/m² or not greater than about 490 g/m² or not greater than about 480 g/m² or not greater than about 470 g/m² or not greater than about 460 g/m² or not greater than about 450 g/m² or not greater than about 440 g/m² or not greater than about 430 g/m² or not greater than about 420 g/m² or not greater than about 410 g/m² or not greater than about 400 g/m².

Embodiment 8. The battery pack spacer of any one of embodiments 1, 2, and 3, wherein the compressible sheet comprises a surface density of at least about 50 g/m².

Embodiment 9. The battery pack spacer of any one of embodiments 1, 2, and 3, wherein the compressible sheet comprises a densification strain of at least about 40% or at least about 41% or at least about 42% or at least about 43% or at least about 44% or at least about 45% or at least about 46% or at least about 47% or at least about 48% or at least about 49% or at least about 50% or at least about 51% or at least about 52% or at least about 53% or at least about 54% or at least about 55% or at least about 56% or at least about 57% or at least about 58% or at least about 59% or at least about 60% or at least about 61% or at least about 62% or at least about 63% or at least about 64% or at least about 65% or at least about 66% or at least about 67% or at least about 68% or at least about 69% or at least about 70% or at least about 71% or at least about 72% or at least about 73% or at least about 74% or at least about 75% or at least about 76% or at least about 77% or at least about 78% or at least about 79% or at least about 80% or at least about 81% or at least about 82% or at least about 83% or at least about 84% or at least about 85% or at least about 86% or at least about 87% or at least about 88% or at least about 89% or at least about 90%.

Embodiment 10. The battery pack spacer of any one of embodiments 1, 2, and 3, wherein the compressible sheet comprises a densification strain of not greater than about 99%.

Embodiment 11. The battery pack spacer of any one of embodiments 1, 2, and 3, wherein the structured core comprises a cellular lattice structure of support walls orthogonal to a longitudinal plane of the compressible sheet.

Embodiment 12. The battery pack spacer of embodiment 11, wherein the cellular lattice structure comprises a regular lattice-type pattern of cells.

Embodiment 13. The battery pack spacer of embodiment 12, wherein the cellular lattice structure comprises a regular lattice-type pattern of open cells.

Embodiment 14. The battery pack spacer of embodiment 12, wherein the cellular lattice structure comprises a regular lattice-type pattern of closed cells.

Embodiment 15. The battery pack spacer of embodiment 12, wherein the regular lattice-type pattern of cells comprises a regular lattice-type pattern of hexagonal cells.

Embodiment 16. The battery pack spacer of embodiment 11, wherein the support walls of the cellular lattice structure have a uniform thickness.

Embodiment 17. The battery pack spacer of embodiment 11, wherein the support walls of the cellular lattice structure have an average thickness CLS_{T} and a height CLS_{H}, wherein the aspect ratio CLS_{H}/CLS_{T} of the support walls is at least about 1 or at least about 2 or at least about 3 or at least about 4.

Embodiment 18. The battery pack spacer of embodiment 17, wherein the aspect ratio CLS_{H}/CLS_{T} of the support walls is not greater than about 30 or not greater than about 28 or not greater than about 26 or not greater than about 24 or not greater than about 22 or not greater than about 20 or not greater than about 18 or not greater than about 16 or not greater than about 14 or not greater than about 12 or not greater than about 10.

Embodiment 19. The battery pack spacer of embodiment 11, wherein the support walls of the cellular lattice structure have a height CLS_{H} of not greater than about 5 mm or not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or not greater than about 0.2 mm.

Embodiment 20. The battery pack spacer of embodiment 11, wherein the support walls of the cellular lattice structure have a height CLS_{H} of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm.

Embodiment 21. The battery pack spacer of embodiment 11, wherein the support walls of the cellular lattice structure have an average thickness CLS_{T} of not greater than about 1 mm or not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1 mm or not greater than about 0.09 mm or not greater than about 0.08 mm or not greater than about 0.07 mm or not greater than about 0.06 mm or not greater than about 0.05 mm.

Embodiment 22. The battery pack spacer of embodiment 11, wherein the support walls of the cellular lattice structure have an average thickness CLS_{T} of at least about 0.001 mm or at least about 0.005 mm or at least about 0.01 mm or at least about 0.015 mm or at least about 0.02 mm or at least about 0.025 mm or at least about 0.03 mm or at least about 0.035 mm or at least about 0.04 mm or at least about 0.045 mm.

Embodiment 23. The battery pack spacer of embodiment 11, wherein the cellular lattice structure comprises support wall units having an average length CLS_{WL} of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 1 mm or at least about 2 mm or at least about 3 mm or at least about 4 mm or at least about 5 mm or at least about 6 mm.

Embodiment 24. The battery pack spacer of embodiment 11, wherein the cellular lattice structure comprises support wall units having an average length CLS_{WL} of not greater than about 15 mm or not greater than about 14 mm or not greater than about 13 mm or not greater than about 12 mm or not greater than about 11 mm or not greater than about 10 mm.

Embodiment 25. The battery pack spacer of embodiment 11, wherein the cellular lattice structure comprises a volume density of at least about 10 g/L or at least about 20 g/L or at least about 30 g/L or at least about 40 g/L or at least about 50 g/L or at least about 60 g/L or at least about 70 g/L or at least about 80 g/L or at least about 90 g/L.

Embodiment 26. The battery pack spacer of embodiment 11, wherein the cellular lattice structure comprises a volume density of not greater than about 500 g/L or not greater than about 400 g/L or not greater than about 300 g/L or not greater than about 200 g/L or not greater than about 100 g/L.

Embodiment 27. The battery pack spacer of embodiment 11, wherein the cellular lattice structure comprises an out of plane compressive stress as measured at 40% strain of at least about 10 kPa or at least about 15 kPa or at least about 20 kPa or at least about 25 kPa or at least about 30 kPa or at least about 35 kPa or at least about 40 kPa or at least about 45 kPa.

Embodiment 28. The battery pack spacer of embodiment 11, wherein the cellular lattice structure comprises an out of plane compressive stress as measured at 40% strain of not greater than about 500 kPa or not greater than about 450 kPa or not greater than about 400 kPa or not greater than about 350 kPa or not greater than about 300 kPa or not greater than about 290 kPa or not greater than about 280 kPa or not greater than about 270 kPa or not greater than about 260 kPa or not greater than about 250 kPa or not greater than about 240 kPa or not greater than about 230 kPa or not greater than about 220 kPa or not greater than about 210 kPa or not greater than about 200 kPa.

Embodiment 29. The battery pack spacer of any one of embodiments 1, 2, and 3, wherein the structured core comprises a corrugated structure.

Embodiment 30. The battery pack spacer of embodiment 29, wherein corrugated structure is a corrugated wave structure.

Embodiment 31. The battery pack spacer of embodiment 30, wherein the corrugated wave structure comprises a sheet undulating in an oscillating wave pattern of successive wave-troughs and wave-crests, wherein the wave-troughs and the wave-crests run a width of the structured core.

Embodiment 32. The battery pack spacer of embodiment 31, wherein the wave-troughs and the wave-crests have a generally trapezoidal shape.

Embodiment 33. The battery pack spacer of embodiment 31, wherein the wave-troughs and the wave-crests have a generally triangular shape.

Embodiment 34. The battery pack spacer of embodiment 31, wherein the wave-troughs and the wave-crests have a generally rectangular shape.

Embodiment 35. The battery pack spacer of embodiment 31, wherein the oscillating wave pattern of the sheet has a height CWS_{H} and a period CWS_{P}, and wherein the aspect ratio CWS_{H}/CWS_{T} of the sheet is at least about 1 or at least about 2 or at least about 3 or at least about 4.

Embodiment 36. The battery pack spacer of embodiment 31, wherein the sheet of the corrugated wave structure has an average thickness CWS_{T}, wherein the oscillating wave pattern of the sheet has a height CWS_{H} and a period CWS_{P}, and wherein the aspect ratio CWS_{H}/CWS_{T} of the sheet is at least about 1 or at least about 2 or at least about 3 or at least about 4.

Embodiment 37. The battery pack spacer of embodiment 36, wherein the aspect ratio CWS_{H}/CWS_{T} of the sheet is not greater than about 10 or not greater than about 9 or not greater than about 8 or not greater than about 7 or not greater than about 6.

Embodiment 38. The battery pack spacer of embodiment 31, wherein the support walls of the corrugated wave structure has a height CWS_{H} of not greater than about 5 mm or not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or not greater than about 0.2 mm.

Embodiment 39. The battery pack spacer of embodiment 31, wherein the support walls of the corrugated wave structure has a height CWS_{H} of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm.

Embodiment 40. The battery pack spacer of embodiment 31, wherein the support walls of the corrugated wave structure has a period CWS_{P} of not greater than about 15 mm or not greater than about 14 mm or not greater than about 13 mm or not greater than about 12 mm or not greater than about 11 mm or not greater than about 10 mm.

Embodiment 41. The battery pack spacer of embodiment 31, wherein the support walls of the corrugated wave structure has a period CWS_{P} of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 1 mm or at least about 2 mm or at least about 3 mm or at least about 4 mm or at least about 5 mm or at least about 6 mm.

Embodiment 42. The battery pack spacer of embodiment 31, wherein the sheet of the corrugated wave structure has an average thickness CWS_{T} of not greater than about 1 mm or not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1 mm or not greater than about 0.09 mm or not greater than about 0.08 mm or not greater than about 0.07 mm or not greater than about 0.06 mm or not greater than about 0.05 mm.

Embodiment 43. The battery pack spacer of embodiment 31, wherein the sheet of the corrugated wave structure has an average thickness CWS_{T} of at least about 0.001 mm or at least about 0.005 mm or at least about 0.01 mm or at least about 0.015 mm or at least about 0.02 mm or at least about 0.025 mm or at least about 0.03 mm or at least about 0.035 mm or at least about 0.04 mm or at least about 0.045 mm.

Embodiment 44. The battery pack spacer of embodiment 29, wherein the corrugated structure is a corrugated beam structure.

Embodiment 45. The battery pack spacer of embodiment 44, wherein the structured core comprises a plurality of support walls orthogonal to a longitudinal plane of the compressible sheet, wherein the plurality of support walls are parallel to each other and run a width of the structured core.

Embodiment 46. The battery pack spacer of embodiment 45, wherein the support walls of the corrugated beam structure have an average thickness CBS_{T} and a height CBS_{H}, wherein the aspect ratio CBS_{H}/CBS_{T} of the support walls is at least about 1 or at least about 2 or at least about 3 or at least about 4.

Embodiment 47. The battery pack spacer of embodiment 46, wherein the aspect ratio CBS_{H}/CBS_{T} of the support walls is not greater than about 10 or not greater than about 9 or not greater than about 8 or not greater than about 7 or not greater than about 6.

Embodiment 48. The battery pack spacer of embodiment 44, wherein the support walls of the corrugated beam structure have a height CBS_{H} of not greater than about 5 mm or not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or not greater than about 0.2 mm.

Embodiment 49. The battery pack spacer of embodiment 44, wherein the support walls of the corrugated beam structure have a height CBS_{H} of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm.

Embodiment 50. The battery pack spacer of embodiment 44, wherein the support walls of the corrugated beam structure have an average thickness CBS_{T} of not greater than about 1 mm or not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1 mm or not greater than about 0.09 mm or not greater than about 0.08 mm or not greater than about 0.07 mm or not greater than about 0.06 mm or not greater than about 0.05 mm.

Embodiment 51. The battery pack spacer of embodiment 44, wherein the support walls of the corrugated beam structure have an average thickness CBS_{T} of at least about 0.001 mm or at least about 0.005 mm or at least about 0.01 mm or at least about 0.015 mm or at least about 0.02 mm or at least about 0.025 mm or at least about 0.03 mm or at least about 0.035 mm or at least about 0.04 mm or at least about 0.045 mm.

Embodiment 52. The battery pack spacer of embodiment 44, wherein the corrugated beam structure comprises a surface density of not greater than about 600 g/m² or not greater than about 590 g/m² or not greater than about 580 g/m² or not greater than about 570 g/m² or not greater than about 560 g/m² or not greater than about 550 g/m² or not greater than about 540 g/m² or not greater than about 530 g/m² or not greater than about 520 g/m² or not greater than about 510 g/m² or not greater than about 500 g/m² or not greater than about 490 g/m² or not greater than about 480 g/m² or not greater than about 470 g/m² or not greater than about 460 g/m² or not greater than about 450 g/m² or not greater than about 440 g/m² or not greater than about 430 g/m² or not greater than about 420 g/m² or not greater than about 410 g/m² or not greater than about 400 g/m².

Embodiment 53. The battery pack spacer of embodiment 44, wherein the corrugated beam structure comprises a surface density of at least about 50 g/m².

Embodiment 54. The battery pack spacer of embodiment 44, wherein the corrugated beam structure comprises a stress as measured at 40% strain of at least about 10 kPa or at least about 15 kPa or at least about 20 kPa or at least about 25 kPa or at least about 30 kPa or at least about 35 kPa or at least about 40 kPa or at least about 45 kPa.

Embodiment 55. The battery pack spacer of embodiment 44, wherein the corrugated beam structure comprises a stress as measured at 40% strain of not greater than about 500 kPa or not greater than about 450 kPa or not greater than about 400 kPa or not greater than about 350 kPa or not greater than about 300 kPa or not greater than about 290 kPa or not greater than about 280 kPa or not greater than about 270 kPa or not greater than about 260 kPa or not greater than about 250 kPa or not greater than about 240 kPa or not greater than about 230 kPa or not greater than about 220 kPa or not greater than about 210 kPa or not greater than about 200 kPa.

Embodiment 56. A compressible sheet, wherein the compressible sheet comprises a structured core; wherein the structured core comprises an elastomer material; and wherein the compressible sheet has an average height of not greater than about 5 mm.

Embodiment 57. A compressible sheet, wherein the compressible sheet comprises a structured core; wherein the structured core comprises an elastomer material; and wherein the compressible sheet comprises a surface density of not greater than about 500 g/m².

Embodiment 58. A compressible sheet, wherein the compressible sheet comprises a structured core; wherein the structured core comprises an elastomer material; and wherein the compressible sheet comprises a densification strain of at least about 40%.

Embodiment 59. The compressible sheet of any one of embodiments 56, 57, and 58, wherein the elastomer material comprises thermoplastic material, wherein the thermoplastic material comprises thermoplastic elastomers, wherein the elastomers comprise cross-linkable elastomeric polymers of natural or synthetic origin, wherein the elastomers comprise silicone, natural rubber, urethane, olefinic elastomer, diene elastomer, blend of olefinic or diene elastomer, fluoroelastomer, perfluoroelastomer, or any combination thereof, wherein the elastomer comprises polyurethane.

Embodiment 60. The compressible sheet of any one of embodiments 56, 57, and 58, wherein the compressible sheet has an average height of not greater than about 5 mm or not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or not greater than about 0.2 mm.

Embodiment 61. The compressible sheet of any one of embodiments 56, 57, and 58, wherein the compressible sheet has an average height of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm.

Embodiment 62. The compressible sheet of any one of embodiments 56, 57, and 58, wherein the compressible sheet comprises a surface density of not greater than about 600 g/m² or not greater than about 590 g/m² or not greater than about 580 g/m² or not greater than about 570 g/m² or not greater than about 560 g/m² or not greater than about 550 g/m² or not greater than about 540 g/m² or not greater than about 530 g/m² or not greater than about 520 g/m² or not greater than about 510 g/m² or not greater than about 500 g/m² or not greater than about 490 g/m² or not greater than about 480 g/m² or not greater than about 470 g/m² or not greater than about 460 g/m² or not greater than about 450 g/m² or not greater than about 440 g/m² or not greater than about 430 g/m² or not greater than about 420 g/m² or not greater than about 410 g/m² or not greater than about 400 g/m².

Embodiment 63. The compressible sheet of any one of embodiments 56, 57, and 58, wherein the compressible sheet comprises a densification strain of at least about 40% or at least about 41% or at least about 42% or at least about 43% or at least about 44% or at least about 45% or at least about 46% or at least about 47% or at least about 48% or at least about 49% or at least about 50% or at least about 51% or at least about 52% or at least about 53% or at least about 54% or at least about 55% or at least about 56% or at least about 57% or at least about 58% or at least about 59% or at least about 60% or at least about 61% or at least about 62% or at least about 63% or at least about 64% or at least about 65% or at least about 66% or at least about 67% or at least about 68% or at least about 69% or at least about 70% or at least about 71% or at least about 72% or at least about 73% or at least about 74% or at least about 75% or at least about 76% or at least about 77% or at least about 78% or at least about 79% or at least about 80% or at least about 81% or at least about 82% or at least about 83% or at least about 84% or at least about 85% or at least about 86% or at least about 87% or at least about 88% or at least about 89% or at least about 90%.

Embodiment 64. The compressible sheet of any one of embodiments 56, 57, and 58, wherein the compressible sheet comprises a densification strain of not greater than about 99%.

Embodiment 65. The compressible sheet of any one of embodiments 56, 57, and 58, wherein the compressible sheet comprises a surface density of at least about 50 g/m²_{.}

Embodiment 66. The compressible sheet of any one of embodiments 56, 57, and 58, wherein the structured core comprises a cellular lattice structure of support walls orthogonal to a longitudinal plane of the compressible sheet.

Embodiment 67. The compressible sheet of embodiment 66, wherein the cellular lattice structure comprises a regular lattice-type pattern of cells.

Embodiment 68. The compressible sheet of embodiment 67, wherein the cellular lattice structure comprises a regular lattice-type pattern of open cells.

Embodiment 69. The compressible sheet of embodiment 67, wherein the cellular lattice structure comprises a regular lattice-type pattern of closed cells.

Embodiment 70. The compressible sheet of embodiment 67, wherein the regular lattice-type pattern of cells comprises a regular lattice-type pattern of hexagonal cells.

Embodiment 71. The compressible sheet of embodiment 66, wherein the support walls of the cellular lattice structure have a uniform thickness.

Embodiment 72. The compressible sheet of embodiment 66, wherein the support walls of the cellular lattice structure have an average thickness CLS_{T} and a height CLS_{H}, wherein the aspect ratio CLS_{H}/CLS_{T} of the support walls is at least about 1 or at least about 2 or at least about 3 or at least about 4.

Embodiment 73. The compressible sheet of embodiment 72, wherein the aspect ratio CLS_{H}/CLS_{T} of the support walls is not greater than about 30 or not greater than about 28 or not greater than about 26 or not greater than about 24 or not greater than about 22 or not greater than about 20 or not greater than about 18 or not greater than about 16 or not greater than about 14 or not greater than about 12 or not greater than about 10.

Embodiment 74. The compressible sheet of embodiment 66, wherein the support walls of the cellular lattice structure have a height CLS_{H} of not greater than about 5 mm or not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or not greater than about 0.2 mm.

Embodiment 75. The compressible sheet of embodiment 66, wherein the support walls of the cellular lattice structure have a height CLS_{H} of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm.

Embodiment 76. The compressible sheet of embodiment 66, wherein the support walls of the cellular lattice structure have an average thickness CLS_{T} of not greater than about 1 mm or not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1 mm or not greater than about 0.09 mm or not greater than about 0.08 mm or not greater than about 0.07 mm or not greater than about 0.06 mm or not greater than about 0.05 mm.

Embodiment 77. The compressible sheet of embodiment 66, wherein the support walls of the cellular lattice structure have an average thickness CLS_{T} of at least about 0.001 mm or at least about 0.005 mm or at least about 0.01 mm or at least about 0.015 mm or at least about 0.02 mm or at least about 0.025 mm or at least about 0.03 mm or at least about 0.035 mm or at least about 0.04 mm or at least about 0.045 mm.

Embodiment 78. The compressible sheet of embodiment 66, wherein the cellular lattice structure comprises support wall units having an average length CLS_{WL} of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 1 mm or at least about 2 mm or at least about 3 mm or at least about 4 mm or at least about 5 mm or at least about 6 mm.

Embodiment 79. The compressible sheet of embodiment 66, wherein the cellular lattice structure comprises support wall units having an average length CLS_{WL} of not greater than about 15 mm or not greater than about 14 mm or not greater than about 13 mm or not greater than about 12 mm or not greater than about 11 mm or not greater than about 10 mm.

Embodiment 80. The compressible sheet of embodiment 66, wherein the cellular lattice structure comprises a volume density of at least about 10 g/L or at least about 20 g/L or at least about 30 g/L or at least about 40 g/L or at least about 50 g/L or at least about 60 g/L or at least about 70 g/L or at least about 80 g/L or at least about 90 g/L.

Embodiment 81. The compressible sheet of embodiment 66, wherein the cellular lattice structure comprises a volume density of not greater than about 500 g/L or not greater than about 400 g/L or not greater than about 300 g/L or not greater than about 200 g/L or not greater than about 100 g/L.

Embodiment 82. The compressible sheet of embodiment 66, wherein the cellular lattice structure comprises an out of plane compressive stress as measured at 40% strain of at least about 10 kPa or at least about 15 kPa or at least about 20 kPa or at least about 25 kPa or at least about 30 kPa or at least about 35 kPa or at least about 40 kPa or at least about 45 kPa.

Embodiment 83. The compressible sheet of embodiment 66, wherein the cellular lattice structure comprises an out of plane compressive stress as measured at 40% strain of not greater than about 500 kPa or not greater than about 450 kPa or not greater than about 400 kPa or not greater than about 350 kPa or not greater than about 300 kPa or not greater than about 290 kPa or not greater than about 280 kPa or not greater than about 270 kPa or not greater than about 260 kPa or not greater than about 250 kPa or not greater than about 240 kPa or not greater than about 230 kPa or not greater than about 220 kPa or not greater than about 210 kPa or not greater than about 200 kPa.

Embodiment 84. The compressible sheet of any one of embodiments 56, 57, and 58, wherein the structured core comprises a corrugated structure.

Embodiment 85. The compressible sheet of embodiment 84, wherein corrugated structure is a corrugated wave structure.

Embodiment 86. The compressible sheet of embodiment 85, wherein the corrugated wave structure comprises a sheet undulating in an oscillating wave pattern of successive wave-troughs and wave-crests, wherein the wave-troughs and the wave-crests run a width of the structured core.

Embodiment 87. The compressible sheet of embodiment 86, wherein the wave-troughs and the wave-crests have a generally trapezoidal shape.

Embodiment 88. The compressible sheet of embodiment 86, wherein the wave-troughs and the wave-crests have a generally triangular shape.

Embodiment 89. The compressible sheet of embodiment 86, wherein the wave-troughs and the wave-crests have a generally rectangular shape.

Embodiment 90. The compressible sheet of embodiment 86, wherein the oscillating wave pattern of the sheet has a height CWS_{H} and a period CWS_{P}, and wherein the aspect ratio CWS_{H}/CSW_{T} of the sheet is at least about 1 or at least about 2 or at least about 3 or at least about 4.

Embodiment 91. The compressible sheet of embodiment 86, wherein the sheet of the corrugated wave structure has an average thickness CWS_{T}, wherein the oscillating wave pattern of the sheet has a height CWS_{H} and a period CWS_{P}, and wherein the aspect ratio CWS_{H}/CSW_{T} of the sheet is at least about 1 or at least about 2 or at least about 3 or at least about 4.

Embodiment 92. The compressible sheet of embodiment 91, wherein the aspect ratio CWS_{H}/CSW_{T} of the sheet is not greater than about 10 or not greater than about 9 or not greater than about 8 or not greater than about 7 or not greater than about 6.

Embodiment 93. The compressible sheet of embodiment 85, wherein the support walls of the corrugated wave structure has a height CWS_{H} of not greater than about 5 mm or not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or not greater than about 0.2 mm.

Embodiment 94. The compressible sheet of embodiment 85, wherein the support walls of the corrugated wave structure has a height CWS_{H} of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm.

Embodiment 95. The compressible sheet of embodiment 85, wherein the support walls of the corrugated wave structure has a period CWS_{P} of not greater than about 15 mm or not greater than about 14 mm or not greater than about 13 mm or not greater than about 12 mm or not greater than about 11 mm or not greater than about 10 mm.

Embodiment 96. The compressible sheet of embodiment 44, wherein the support walls of the corrugated wave structure has a period CWS_{P} of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 1 mm or at least about 2 mm or at least about 3 mm or at least about 4 mm or at least about 5 mm or at least about 6 mm.

Embodiment 97. The compressible sheet of embodiment 85, wherein the sheet of the corrugated wave structure has an average thickness CWS_{T} of not greater than about 1 mm or not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1 mm or not greater than about 0.09 mm or not greater than about 0.08 mm or not greater than about 0.07 mm or not greater than about 0.06 mm or not greater than about 0.05 mm.

Embodiment 98. The compressible sheet of embodiment 85, wherein the sheet of the corrugated wave structure has an average thickness CWS_{T} of at least about 0.001 mm or at least about 0.005 mm or at least about 0.01 mm or at least about 0.015 mm or at least about 0.02 mm or at least about 0.025 mm or at least about 0.03 mm or at least about 0.035 mm or at least about 0.04 mm or at least about 0.045 mm.

Embodiment 99. The compressible sheet of embodiment 85, wherein the corrugated structure is a corrugated beam structure.

Embodiment 100. The compressible sheet of embodiment 99, wherein the structured core comprises a plurality of support walls orthogonal to a longitudinal plane of the compressible sheet, wherein the plurality of support wall are parallel to each other and run a width of the structured core.

Embodiment 101. The compressible sheet of embodiment 99, wherein the support walls of the corrugated beam structure have an average thickness CBS_{T} and a height CBS_{H}, wherein the aspect ratio CBS_{H}/CBS_{T} of the support walls is at least about 1 or at least about 2 or at least about 3 or at least about 4.

Embodiment 102. The compressible sheet of embodiment 100, wherein the aspect ratio CBS_{H}/CBS_{T} of the support walls is not greater than about 10 or not greater than about 9 or not greater than about 8 or not greater than about 7 or not greater than about 6.

Embodiment 103. The compressible sheet of embodiment 100, wherein the support walls of the corrugated beam structure have a height CBS_{H} of not greater than about 5 mm or not greater than about 4 mm or not greater than about 3 mm or not greater than about 2 mm or not greater than about 1 mm or not greater than about 0.9 mm or not greater than about 0.8 mm or not greater than about 0.5 mm or not greater than about 0.4 mm or not greater than about 0.3 mm or not greater than about 0.2 mm.

Embodiment 104. The compressible sheet of embodiment 100, wherein the support walls of the corrugated beam structure have a height CBS_{H} of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm.

Embodiment 105. The compressible sheet of embodiment 100, wherein the support walls of the corrugated beam structure have an average thickness CBS_{T} of not greater than about 1 mm or not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1 mm or not greater than about 0.09 mm or not greater than about 0.08 mm or not greater than about 0.07 mm or not greater than about 0.06 mm or not greater than about 0.05 mm.

Embodiment 106. The compressible sheet of embodiment 100, wherein the support walls of the corrugated beam structure have an average thickness CBS_{T} of at least about 0.001 mm or at least about 0.005 mm or at least about 0.01 mm or at least about 0.015 mm or at least about 0.02 mm or at least about 0.025 mm or at least about 0.03 mm or at least about 0.035 mm or at least about 0.04 mm or at least about 0.045 mm.

Embodiment 107. The compressible sheet of embodiment 100, wherein the corrugated beam structure comprises a surface density of not greater than about 600 g/m² or not greater than about 590 g/m² or not greater than about 580 g/m² or not greater than about 570 g/m² or not greater than about 560 g/m² or not greater than about 550 g/m² or not greater than about 540 g/m² or not greater than about 530 g/m² or not greater than about 520 g/m² or not greater than about 510 g/m² or not greater than about 500 g/m² or not greater than about 490 g/m² or not greater than about 480 g/m² or not greater than about 470 g/m² or not greater than about 460 g/m² or not greater than about 450 g/m² or not greater than about 440 g/m² or not greater than about 430 g/m² or not greater than about 420 g/m² or not greater than about 410 g/m² or not greater than about 400 g/m².

Embodiment 108. The compressible sheet of embodiment 100, wherein the corrugated beam structure comprises a surface density of at least about 50 g/m².

Embodiment 109. The compressible sheet of embodiment 100, wherein the corrugated beam structure comprises an out of plane compressive stress as measured at 40% strain of at least about 10 kPa or at least about 15 kPa or at least about 20 kPa or at least about 25 kPa or at least about 30 kPa or at least about 35 kPa or at least about 40 kPa or at least about 45 kPa.

Embodiment 110. The compressible sheet of embodiment 100, wherein the corrugated beam structure comprises an out of plane compressive stress as measured at 40% strain of not greater than about 500 kPa or not greater than about 450 kPa or not greater than about 400 kPa or not greater than about 350 kPa or not greater than about 300 kPa or not greater than about 290 kPa or not greater than about 280 kPa or not greater than about 270 kPa or not greater than about 260 kPa or not greater than about 250 kPa or not greater than about 240 kPa or not greater than about 230 kPa or not greater than about 220 kPa or not greater than about 210 kPa or not greater than about 200 kPa.

Embodiment 111. The compressible sheet of any one of embodiments 56, 57, and 58, wherein the structured core comprises a multi-layer composite.

Embodiment 112. The compressible sheet of embodiment 111, wherein the multi-layer composite comprises at least a first core layer and a second core layer, wherein the first core layer is distinct from the second core layer.

Embodiment 113. The compressible sheet of embodiment 112, wherein the first core layer and the second core layer comprise distinct materials.

Embodiment 114. The compressible sheet of any one of embodiments 56, 57, and 58, wherein the compressible sheet further comprises a first skin-layer adjacent to a first surface of the structured core.

Embodiment 115. The compressible sheet of embodiment 114, wherein the compressible sheet further comprises a first adhesive overlying an outer surface of the first skin-layer.

Embodiment 116. The compressible sheet of embodiment 114, wherein the compressible sheet further comprises an second skin-layer adjacent to a second surface of the structured core that is opposite of and parallel to the first surface of the structured core.

Embodiment 117. The compressible sheet of embodiment 116, wherein the compressible sheet further comprises a second adhesive overlying an outer surface of the second skin-layer.

Embodiment 118. The compressible sheet of any one of embodiments 56, 57, and 58, wherein the compressible sheet further comprises a first adhesive overlying a first outer surface of the structured core.

Embodiment 119. The compressible sheet of embodiment 118, wherein the compressible sheet further comprises a second adhesive overlying a second outer surface of the of the structured core that is opposite of and parallel to the first surface of the structured core.

Embodiment 120. The battery pack spacer of any one of embodiments 1, 2, and 3, wherein the structured core comprises a multi-layer composite.

Embodiment 121. The battery pack spacer of embodiment 120, wherein the multi-layer composite comprises at least a first core layer and a second core layer, wherein the first core layer is distinct from the second core layer.

Embodiment 122. The battery pack spacer of embodiment 121, wherein the first core layer and the second core layer comprise distinct materials.

Embodiment 123. The battery pack spacer of any one of embodiments 1, 2, and 3, wherein the compressible sheet further comprises a first skin-layer adjacent to a first surface of the structured core.

Embodiment 124. The battery pack spacer of embodiment 123, wherein the compressible sheet further comprises a first adhesive overlying an outer surface of the first skin-layer.

Embodiment 125. The battery pack spacer of embodiment 123, wherein the compressible sheet further comprises an second skin-layer adjacent to a second surface of the structured core that is opposite of and parallel to the first surface of the structured core.

Embodiment 126. The battery pack spacer of embodiment 125, wherein the compressible sheet further comprises a second adhesive overlying an outer surface of the second skin-layer.

Embodiment 127. The battery pack spacer of any one of embodiments 1, 2, and 3, wherein the compressible sheet further comprises a first adhesive overlying a first outer surface of the structured core.

Embodiment 128. The battery pack spacer of embodiment 127, wherein the compressible sheet further comprises a second adhesive overlying a second outer surface of the of the structured core that is opposite of and parallel to the first surface of the structured core.

Embodiment 129. The compressible sheet of claim 116, wherein the first and second skin layers are sealed together around a first outer edge of the structured core.

Embodiment 130. The compressible sheet of claim 129, wherein the first and second skin layers are sealed together around a second outer edge of the structured core that is opposite of the first outer edge of the structured core.

Embodiment 131. The battery pack spacer of claim 125, wherein the first and second skin layers are sealed together around a first outer edge of the structured core.

Embodiment 132. The battery pack spacer of claim 131, wherein the first and second skin layers are sealed together around a second outer edge of the structured core that is opposite of the first outer edge of the structured core.

### EXAMPLES

The concepts described herein will be further described in the following Examples, which do not limit the scope of the invention described in the claims.

### Example 1

Five sample compressible sheets S1-S5 were formed according to embodiments described and having structured parameters according to embodiments described herein. Each of the sample compressible sheets S1-S5 were formed from a silicone material and included a structured cored having a cellular lattice structure with a regular lattice-type pattern of hexagonal shaped cells. The structured parameters of the sample compressible sheets S1-S5 are summarized in Table 1 below.

TABLE 1
Structural Parameters

| | S1 | S2 | S3 | S4 | S5 |
|---|---|---|---|---|---|
| Average Support | 552 | 429 | 466 | 616 | 872 |
| Wall Thickness | | | | | |
| CLS_{T} | | | | | |
| (μm) | | | | | |
| Average Support | 0.84 | 1.87 | 2.95 | 2.96 | 2.91 |
| Wall Height | | | | | |
| CLS_{H} | | | | | |
| (mm) | | | | | |
| Average Support | 6.67 | 6.67 | 6.67 | 6.67 | 6.67 |
| Wall Unit Length | | | | | |
| CLS_{WL} | | | | | |
| (mm) | | | | | |

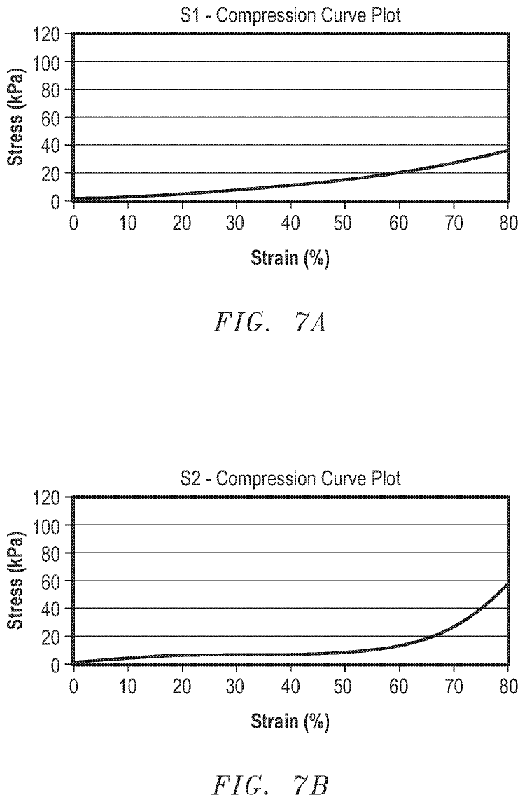

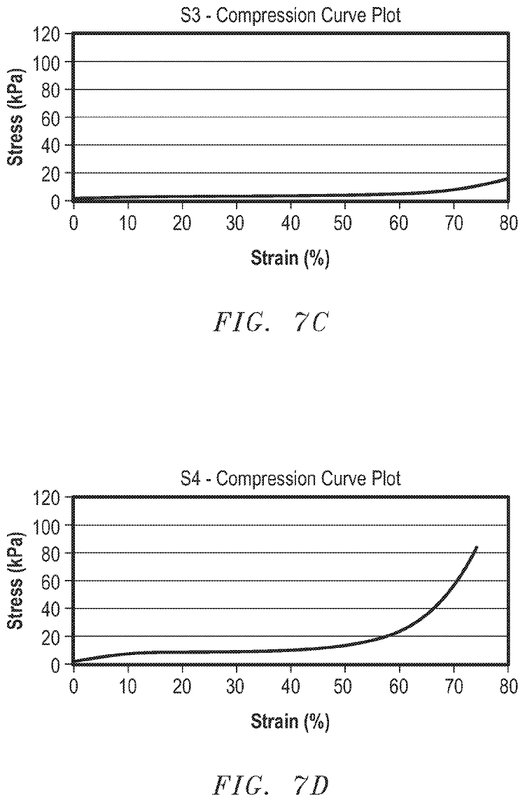

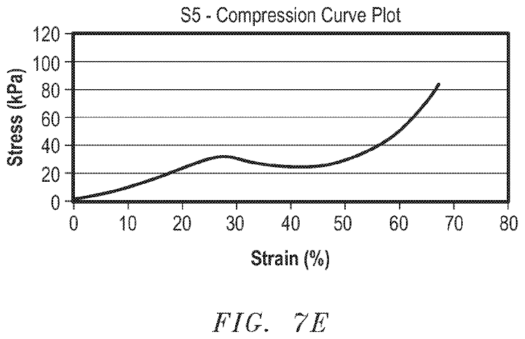

Each sample compressible sheet S1-S5 was tested to determine their volume density and densification strain as described herein. FIGS. 7a-7e include plots of the compression curves for each sample compressible sheet S1-S5. The volume density and the densification strain for each sample compressible sheet S1-S5 are summarized in Table 2 below.

TABLE 2
Volume Density and Densification Strain

| | S1 | S2 | S3 | S4 | S5 |
|---|---|---|---|---|---|
| Volume Density | 120 | 93 | 101 | 134 | 189 |
| (g/L) | | | | | |
| Densification Strain | Not | 47.7 | 55.8 | 45.3 | 54 |
| (%) | applicable | | | | |

### Example 2

Two sample compressible sheets S6 and S7 were formed according to embodiments described and having structured parameters according to embodiments described herein. Each of the sample compressible sheets S6-S7 were formed from a silicone material and included a structured cored having a corrugated wave structure. The structural parameters of the sample compressible sheets S6 and S7 are summarized in Table 3 below.

TABLE 3
Structural Parameters

| | S6 | S7 |
|---|---|---|
| Wave Structure | 140 | 120 |
| Average Thickness | | |
| CWS_{T} | | |
| (μm) | | |
| Wave Structure | 1.05 | 0.98 |
| Average Height | | |
| CWS_{H} | | |
| (mm) | | |
| Wave Structure | 1 | 1 |
| Average Period | | |
| CWS_{P} | | |
| (mm) | | |

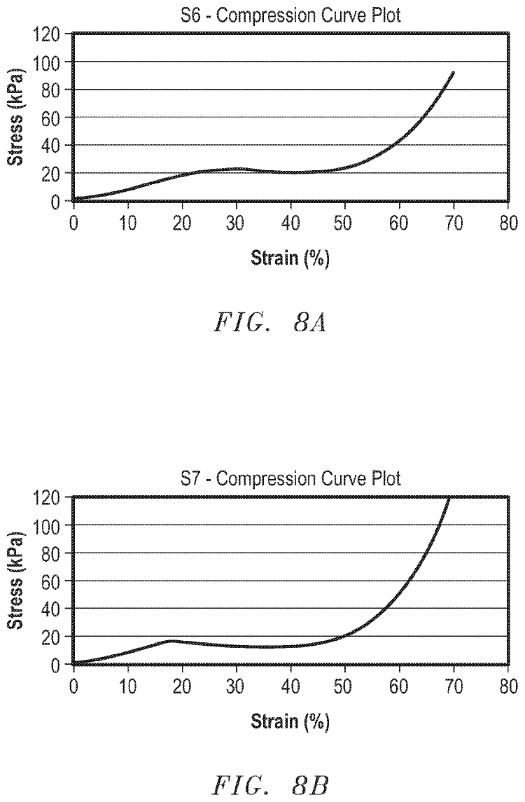

Each sample compressible sheet S6 and S7 were tested to determine their surface density and densification strain as described herein. FIGS. 8a and 8b include plots of the compression curves for each sample compressible sheet S6 and S7. The surface density and the densification strain for each sample compressible sheet S6 and S7 are summarized in Table 4 below.

TABLE 4
Volume Density and Densification Strain

| | S6 | S7 |
|---|---|---|
| Surface Density | 317 | 272 |
| (g/m²) | | |
| Densification Strain | 52 | 47.2 |
| (%) | | |

### Example 3

Two additional sample compressible sheets S8 and S9 were formed according to embodiments described and having structured parameters according to embodiments described herein. Each of the sample compressible sheets S8 and S9 were formed from a silicone material and included a structured cored having a cellular lattice structure with a regular lattice-type pattern of hexagonal shaped cells. The structured parameters of the sample compressible sheets S8 and S9 are summarized in Table 5 below.

TABLE 5
Structured Parameters

| | S8 | S9 |
|---|---|---|
| Average Support | 230 | 175 |
| Wall Thickness | | |
| CLS_{T} | | |
| (μm) | | |
| Average Support | 0.88 | 0.9 |
| Wall Height | | |
| CLS_{H} | | |
| (mm) | | |
| Average Support | 2.86 | 2.14 |
| Wall Unit Length | | |
| CLS_{WL} | | |
| (mm) | | |

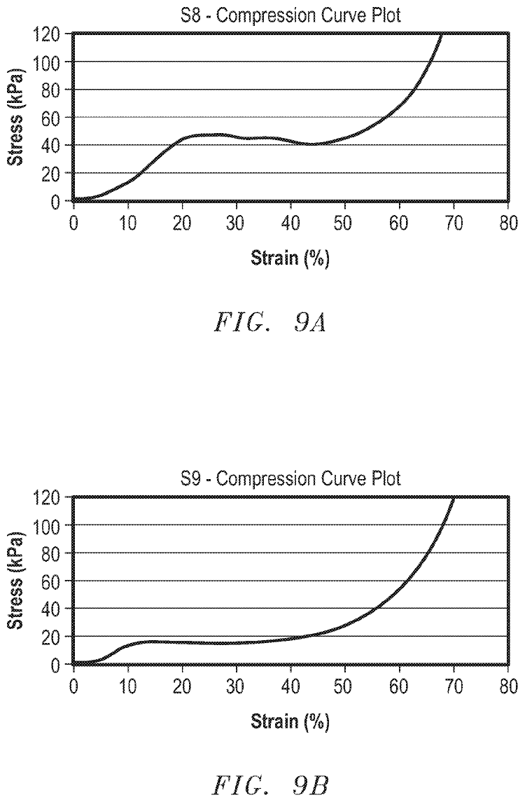

Each sample compressible sheet S8 and S9 was tested to determine their volume density and densification strain as described herein. FIGS. 9a and 9b include plots of the compression curves for each sample compressible sheet S8 and S9. The volume density and the densification strain for each sample compressible sheet S8 and S9 are summarized in Table 6 below.

TABLE 6
Volume Density and Densification Strain

| | S6 | S7 |
|---|---|---|
| Surface Density | 98 | 98 |
| (g/m²) | | |
| Densification Strain | 56 | 42 |
| (%) | | |

### Example 4

Six sample compressible sheets S10-S15 were formed according to embodiments described and having structured parameters according to embodiments described herein. Each of the sample compressible sheets S10 and S11 were formed from a silicone material and included a structured core having a corrugated wave structure. Sample compressible sheets S12 and S13 were formed from a polyurethane material and included a structured core having a corrugated wave structure. Sample compressible sheet S14 was formed from a polyurethane material and included a structured core having a corrugated wave structure and an aluminum skin layer. Sample compressible sheet S15 was formed from a polyurethane material and included a structured core having a corrugated wave structure and adhesives on both sides of the structured core. The structured parameters of the sample compressible sheets S10-S15 are summarized in Table 7 below.

TABLE 7
Structured Parameters

| | S10 | S11 | S12 | S13 | S14 | S15 |
|---|---|---|---|---|---|---|
| Wave Structure | 600 | 400 | 150 | 150 | 150 | 150 |
| Average Thickness | | | | | | |
| CWS_{T} | | | | | | |
| (μm) | | | | | | |
| Wave Structure | 3.2 | 2.16 | 1.7 | 2.4 | 2.9 | 3 |
| Average Height | | | | | | |
| CWS_{H} | | | | | | |
| (mm) | | | | | | |
| Wave Structure | 3 | 2 | 2 | 3 | 3 | 3 |
| Average Period | | | | | | |
| CWS_{P} | | | | | | |
| (mm) | | | | | | |

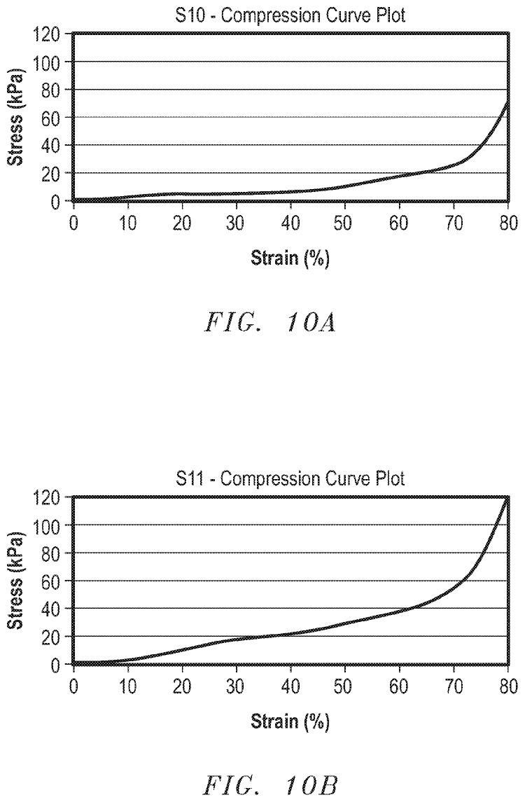

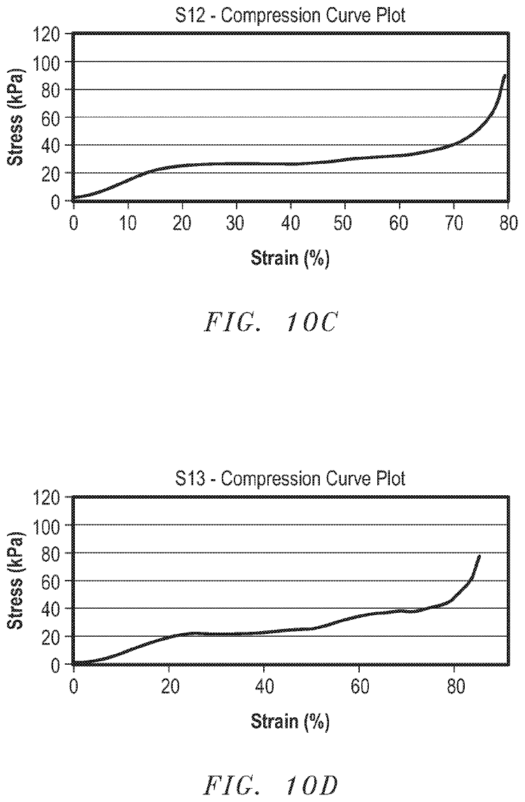

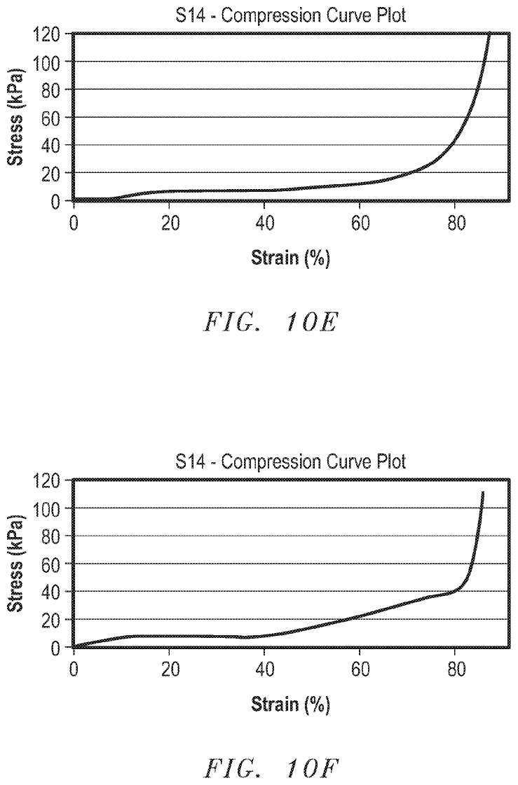

Each sample compressible sheet S10-S15 were tested to determine their surface density and densification strain as described herein. FIGS. 10a-10f include plots of the compression curves for each sample compressible sheet S10-S15. The surface density and the densification strain for each sample compressible sheet S10-S15 are summarized in Table 8 below.

TABLE 8
Volume Density and Densification Strain

| | S10 | S11 | S12 | S13 | S14 | S15 |
|---|---|---|---|---|---|---|
| Surface Density | 1100 | 780 | 210 | 220 | 222 | 219 |
| (g/m²) | | | | | | |
| Densification Strain | 69 | 73 | 65 | 81 | 70 | 42 |
| (%) | | | | | | |

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1.-15. (canceled)

16. A compressible sheet,
wherein the compressible sheet comprises a structured core;
wherein the structured core comprises an elastomer material; and
wherein the compressible sheet has an average height of not greater than about 5 mm.

17. The compressible sheet of claim 16, wherein the elastomer material comprises thermoplastic material.

18. The compressible sheet of claim 16, wherein the compressible sheet has an average height of at least about 0.01 mm.

19. The compressible sheet of claim 16, wherein the compressible sheet comprises a surface density of not greater than about 600 g/m².

20. The compressible sheet of claim 16, wherein the compressible sheet comprises a densification strain of at least about 40%.

21. The compressible sheet of claim 16, wherein the structured core comprises a cellular lattice structure of support walls orthogonal to a longitudinal plane of the compressible sheet.

22. The compressible sheet of claim 21, wherein the cellular lattice structure comprises a regular lattice-type pattern of cells.

23. The compressible sheet of claim 21, wherein the support walls of the cellular lattice structure have an average thickness CLS_{T} and a height CLS_{H}, wherein the aspect ratio CLS_{H}/CLS_{T} of the support walls is at least about 1 and not greater than about 30.

24. The compressible sheet of claim 16, wherein the structured core comprises a corrugated structure.

25. The compressible sheet of claim 24, wherein corrugated structure is a corrugated wave structure.

26. The compressible sheet of claim 25, wherein the corrugated wave structure comprises a sheet undulating in an oscillating wave pattern of successive wave-troughs and wave-crests, wherein the wave-troughs and the wave-crests run a width of the structured core.

27. The compressible sheet of claim 26, wherein the oscillating wave pattern of the sheet has a height CWS_{H} and a period CWS_{P}, and wherein the aspect ratio CWS_{H}/CWS_{T} of the sheet is at least about 1 and not greater than about 10.

28. The compressible sheet of claim 24, wherein the corrugated structure is a corrugated beam structure.

29. A compressible sheet,
wherein the compressible sheet comprises a structured core;
wherein the structured core comprises an elastomer material; and
wherein the compressible sheet comprises a surface density of not greater than about 600 g/m².

30. The compressible sheet of claim 29, wherein the structured core comprises a corrugated structure.

31. The compressible sheet of claim 30, wherein corrugated structure is a corrugated wave structure.

32. The compressible sheet of claim 31, wherein the corrugated wave structure comprises a sheet undulating in an oscillating wave pattern of successive wave-troughs and wave-crests, wherein the wave-troughs and the wave-crests run a width of the structured core.

33. The compressible sheet of claim 32, wherein the oscillating wave pattern of the sheet has a height CWS_{H} and a period CWS_{P}, and wherein the aspect ratio CWS_{H}/CWS_{T} of the sheet is at least about 1 and not greater than about 10.

34. The compressible sheet of claim 30, wherein the corrugated structure is a corrugated beam structure.

35. A battery pack spacer comprising a compressible sheet,
wherein the compressible sheet comprises a structured core;
wherein the structured core comprises an elastomer material; and
wherein the compressible sheet has an average height of not greater than about 5 mm.
